(19) United States
(12) Patent Application Publication
(10) Pub. No.: US 2025/0330752 A1
(43) Pub. Date: Oct. 23, 2025

(54) SYSTEMS, METHODS, AND DEVICES FOR VARIABLE IMPEDANCE AUDIO EQUIPMENT

(71) Applicant: Rockford Corporation, Tempe, AZ (US)

(72) Inventors: Thomas Dubeck, San Tan Valley, AZ (US); Joseph Merritt, Tempe, AZ (US); Garrett Jones, Minneapolis, MN (US)

(73) Assignee: Rockford Corporation, Tempe, AZ (US)

(21) Appl. No.: 19/184,972

(22) Filed: Apr. 21, 2025

Related U.S. Application Data
(60) Provisional application No. 63/636,549, filed on Apr. 19, 2024.

(51) Int. Cl. H04R 9/04; H04R 9/06; H04R 31/00

(52) U.S. Cl. CPC H04R 9/047; H04R 9/06; H04R 31/006; H04R 2400/11

(57) ABSTRACT

Systems, methods, and devices are provided for an audio device comprising: a plurality of voice coils wound around a former, a removable selection plug comprising a plurality of plug positions, a receiving port configured to mate with the removable selection plug, and a plurality of command guides configured to wire the plurality of voice coils into a plurality of wiring configurations, wherein each wiring configuration in the plurality of wiring configurations corresponds to a plug position in the plurality of plug positions, wherein the plurality of voice coils comprises at least four voice coils and the plurality of wiring configurations comprises at least three wiring configurations, and wherein each wiring configuration in the plurality of wiring configurations causes the audio device to have a different impedance value based on a relative orientation of the removable selection plug and the receiving port.

### FIELD OF INVENTION

The present disclosure relates generally to improvements in audio equipment, and, in particular, to enhanced control of variable impedance for users of audio devices.

### BACKGROUND

Every speaker is designed with a set nominal impedance. In various situations, it may be desirable to change the speaker's impedance higher or lower, such as when matching a speaker system with an amplification system. Generally, speakers having variable impedance capabilities can only shift between two impedance options. While these are useful, there is a need for a speaker that can shift between more than two impedance options to enhance the functionality of the speaker and minimize the number of components a user must obtain to complete a diverse array of tasks.

### SUMMARY

In an example embodiment, a method for varying impedance in an audio device is disclosed, comprising: removing a selection plug from a receiving port of the audio device, wherein the selection plug comprises a plurality of command guides configured to wire a plurality of voice coils into a plurality of wiring configurations, wherein each wiring configuration in the plurality of wiring configurations corresponds to a plug position in a plurality of plug positions, wherein the plurality of voice coils comprises at least four voice coils and the plurality of wiring configurations comprises at least three wiring configurations, and wherein the selection plug when removed is at a first plug position in the plurality of plug positions, and inserting the selection plug into the receiving port of the audio device in a second plug position in the plurality of plug positions, wherein the first plug position and the second plug position are different orientations of the selection plug, wherein each wiring configuration in the plurality of wiring configurations is associated with a different impedance value for the audio device.

In various embodiments, the audio device may be a subwoofer or a coaxial speaker. In various embodiments, each voice coil in the plurality of voice coils has a nominal impedance of about 0.8-ohm. In various embodiments, each voice coil in the plurality of voice coils has a nominal impedance of about 4-ohms. In various embodiments, each voice coil in the plurality of voice coils wraps around a former. In various embodiments, each voice coil in the plurality of voice coils wraps from a first end of the former to a second end of the former in a first layer and wraps from the second end of the former to the first end of the former in a second layer. In various embodiments, the audio device produces an impedance value from the group comprising 1-ohm, 2-ohms, 4-ohms, and 8-ohms. In various embodiments, the selection plug further comprises a plurality of fuses configured to interface the plurality of command guides to the plurality of voice coils.

In another example embodiment, an audio device is disclosed, comprising: a plurality of voice coils wound around a former, a removable selection plug comprising a plurality of plug positions, a receiving port configured to mate with the removable selection plug, and a plurality of command guides configured to wire the plurality of voice coils into a plurality of wiring configurations, wherein each wiring configuration in the plurality of wiring configurations corresponds to a plug position in the plurality of plug positions, wherein the plurality of voice coils comprises at least four voice coils and the plurality of wiring configurations comprises at least three wiring configurations, and wherein each wiring configuration in the plurality of wiring configurations causes the audio device to have a different impedance value based on a relative orientation of the removable selection plug and the receiving port.

In various embodiments, each voice coil in the plurality of voice coils is positionally adjacent to another voice coil in the plurality of voice coils. In various embodiments, at least one voice coil in the plurality of voice coils is intertwined with a second voice coil in the plurality of voice coils. In various embodiments, each plug position in the plurality of plug positions is unique.

In various embodiments, the plurality of command guides are disposed within the receiving port, and wherein the removable selection plug comprises a contact interface configured to contact the plurality of command guides in a distinct orientation corresponding to each plug position in the plurality of plug positions. In various embodiments, the removable selection plug further comprises a plurality of fuses configured to interface the plurality of command guides to the plurality of voice coils.

### BRIEF DESCRIPTION OF THE DRAWING FIGURES

Additional aspects of the present disclosure will become evident upon reviewing the non-limiting embodiments described in the specification and the claims taken in conjunction with the accompanying figures, wherein like numerals designate like elements, and:

FIG. 1 is a partial view of an audio device with a variable impedance system according to various embodiments of this disclosure.

FIG. 2A is the front view of an impedance control plug according to various embodiments of this disclosure.

FIG. 2B is a section view of the internal components of impedance control plug according to various embodiments of this disclosure.

FIG. 3 is a perspective view of an audio device with a variable impedance system according to various embodiments of this disclosure.

FIG. 4A is a circuit diagram illustrating a 1-ohm voice coil configuration according to various embodiments of this disclosure.

FIG. 4B is a circuit diagram illustrating a 2-ohm voice coil configuration according to various embodiments of this disclosure.

FIG. 4C is a circuit diagram illustrating a 4-ohm voice coil configuration according to various embodiments of this disclosure.

FIG. 5A is a circuit diagram illustrating a 1-ohm voice coil configuration according to various embodiments of this disclosure.

FIG. 5B is a circuit diagram illustrating a 2-ohm voice coil configuration according to various embodiments of this disclosure.

FIG. 5C is a circuit diagram illustrating a 4-ohm voice coil configuration according to various embodiments of this disclosure.

FIG. 5D is a circuit diagram illustrating an 8-ohm voice coil configuration according to various embodiments of this disclosure.

### DETAILED DESCRIPTION

Reference will now be made to the exemplary embodiments illustrated in the drawings, and specific language will be used herein to describe the same. It will nevertheless be understood that no limitation of the scope of the disclosure is thereby intended. Alterations and further modifications of the inventive features illustrated herein, and additional applications of the principles of the disclosure as illustrated herein, which would occur to one skilled in the relevant art and having possession of this disclosure, are to be considered within the scope of the disclosure.

In accordance with an example embodiment, systems devices methods are provided for an improved variable impedance system. In various embodiments, the speaker may be a subwoofer or a traditional coaxial speaker, however, other audio devices are within the scope of this disclosure.

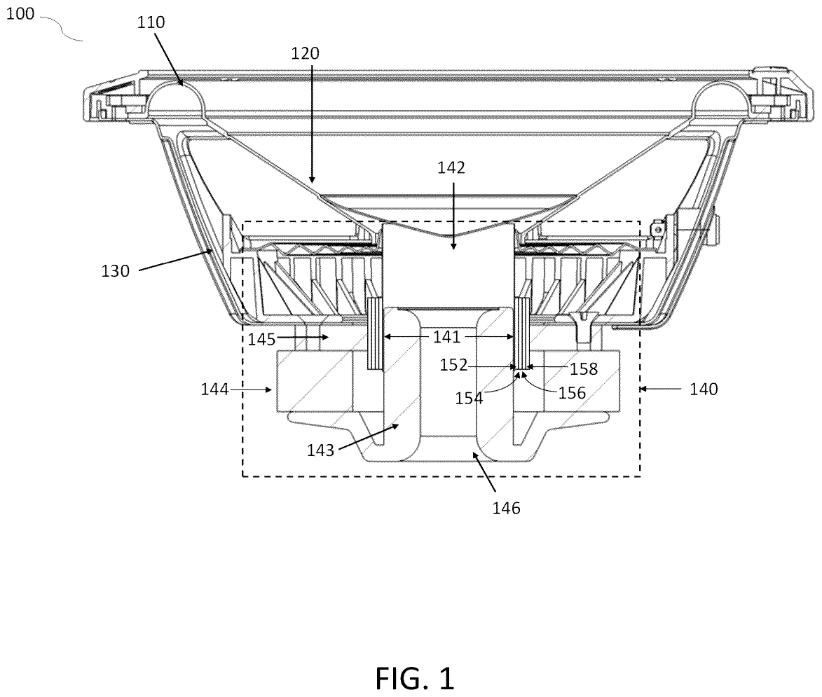

With reference now to FIG. 1, a speaker 100 having an improved variable impedance system in accordance with various embodiments of this disclosure is shown. Speaker 100 comprises a surround 110 configured to suspend diaphragm 120 within frame 130. Surround 110 is coupled to a top surface of frame 130. Speaker 100 further comprises motor structure 140.

Motor structure 140 is disposed within and positioned at the center vertical axis of frame 130. In various embodiments, motor structure 140 comprises a voice coil structure 141 which winds around former 142 and is configured to receive a current from an external source (not shown) and, in response to receiving the current, produce a magnetic field. In various embodiments, voice coil structure 141 may comprise a plurality of voice coils. In various embodiments, voice coil structure 141 may comprise four or more voice coils. In another example embodiment, the voice coil structure 141 may comprise three or more voice coils.

In various embodiments, motor structure 140 further comprises pole 143, which is positioned along the central vertical axis of frame 130 and extends from the base of frame 130 through to former 142, which surrounds a top portion of pole 143. Motor structure 140 further comprises magnet structure 144, which is configured to apply a magnetic force towards voice coil structure 141. In response to receiving the magnetic force, the magnetic field produced by voice coil structure 141 alternatively is repelled and attracted by the magnetic force. In various embodiments, the interaction between the magnetic field and the magnetic force moves voice coil structure 141 and former 142 in an undulating motion up and down pole 143, which in turn moves diaphragm 120, vibrating the air around diaphragm 120 and producing sound waves. In various embodiments, magnet structure 144 may be a permanent magnet. In various embodiments, magnet structure 144 may be a plurality of magnets, wherein at least one magnet in the plurality of magnets is stacked on top of a second magnet in the plurality of magnets. Top plate 145 and a bottom plate 146 complete a magnetic circuit in motor structure 140. In various embodiments, pole 143 may comprise bottom plate 146. In other embodiments, pole 143 and bottom place 146 may be discrete components, such that bottom plate 146 is disposed below pole 143.

Motor structure 140 as illustrated in FIG. 1 is only an example of a motor structure that can be used in the instant invention. In other embodiments, motor structure 140 may be comprised of any known elements and configurations that create a magnetic field for interaction with voice coil structure 141.

In various embodiments, voice coil structure 141 may comprise first coil 152, second coil 154, third coil 156, and fourth coil 158. In such embodiments, first coil 152, second coil 154, third coil 156, and fourth coil 158 may be formed from electrically conductive wire and wind around former 142. In various embodiments, coils 152, 154, 156, and 158 may be comprised of a single layer or a multi-layer winding and may be configured to wind adjacent to each other or intertwined. For example, in a single layer wiring, coils 152, 154, 156, and 158 may wind from the top to bottom of former 142 and contact an electrically conductive strip (not shown) spanning the length of the former, such that the conductive strip carries the current from the bottom of former 142 to top of former 142. In various embodiments, the conductive strip may comprise a foil jumper. In an alternate embodiment, a multi-layer winding may comprise, for example, coils 152, 154, 156, and 158 may wind from the top to bottom of former 142 and then reverse vertical direction and wind back up former 142 from bottom to top.

In various embodiments, coils 152, 154, 156, and 158 may be connected in various combinations in either series and/or parallel to allow for variations in the nominal impedance of speaker 100. In various embodiments, speaker 100 may shift between 1-ohm, 2-ohms, and 4-ohms. In other embodiments, speaker 100 may shift between 1-ohm, 2-ohms, 4-ohms, and 8-ohms. However, other impedance combinations are within the scope of this disclosure.

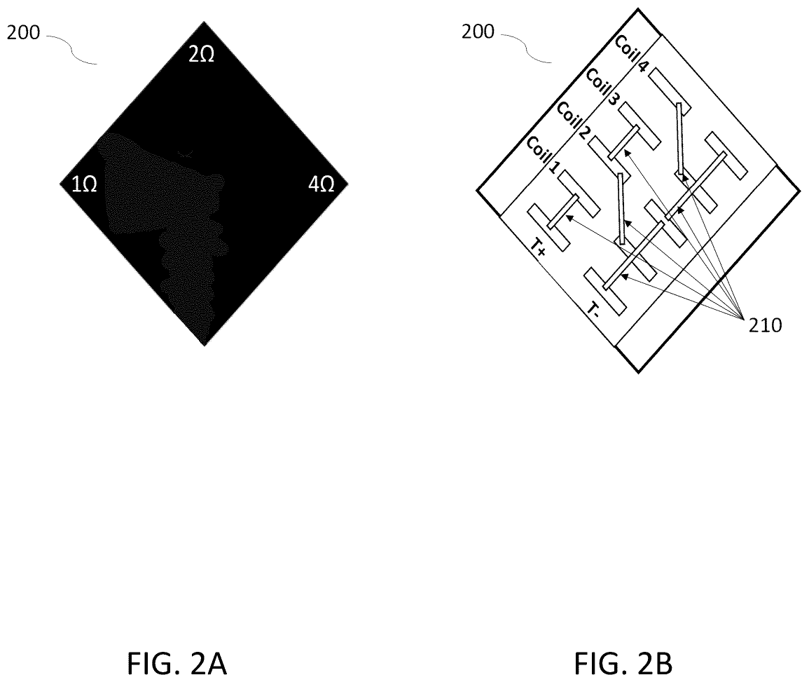

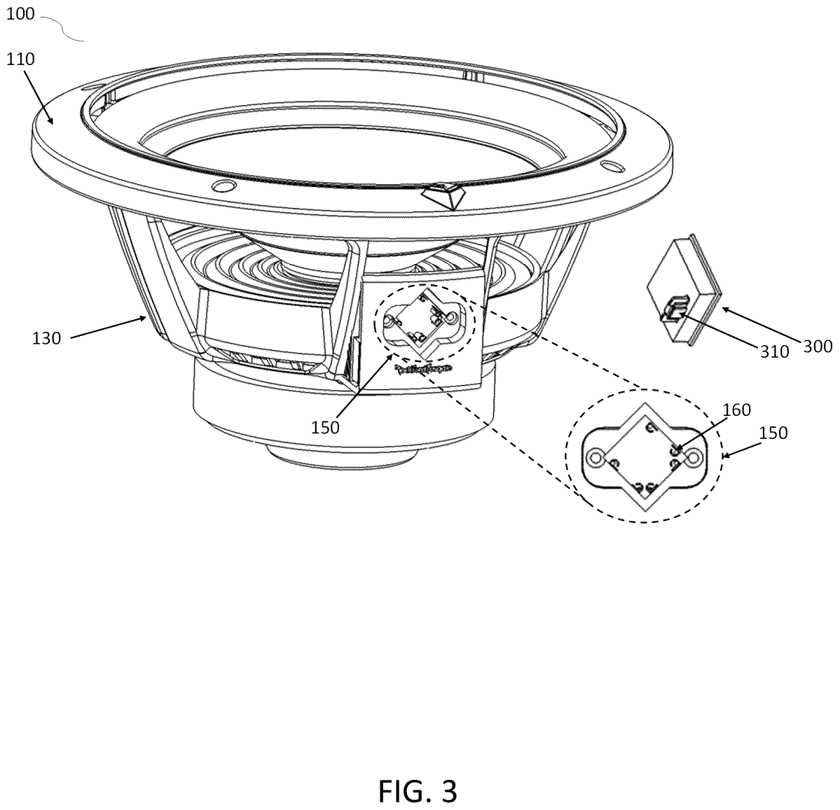

In various embodiments, speaker 100 may shift between impedances through the use of a selection plug 200, as shown in FIGS. 2A and 2B. Stated another way, speaker 100 and selection plug 200 are configured such that the orientation of selection plug 200 when inserted in a receiving port 150 (as see on FIG. 3), changes the impedance of speaker 100. As can be seen in FIG. 2A, the front of selection plug 200 has a plurality of plug positions, each representing an impedance output for an audio device. Each plug position corresponds to a wiring configuration, allowing users to quickly determine what position the plug 200 must be in for the audio device to have a desired nominal impedance.

In an example embodiment, the front of selection plug 200 comprises markings that indicate the orientation for insertion to achieve a desired speaker 100 impedance. For example, a first corner may be marked with a 1 ohm symbol, a second corner marked with a 2 ohm symbol, and a third corner marked with a 4 ohm symbol. In this example embodiment, if the selection plug is inserted with the marked symbol aligned with a corresponding mark on the receiving port 150, the impedance of the speaker 100 will be that indicated with the marking. In various embodiments, the selection plug can be marked in any way that facilitates manual alignment with the receiving port to obtain a desired speaker 100 impedance.

In various embodiments, receiving port 150 may be placed on speaker 100 as shown in FIG. 3. However, receiving port 150 is not limited to the placement shown, and may be placed at any location on speaker 100 sufficient to facilitate the changing of the impedance of speaker 100 through the use of selection plug 200. In various embodiments, receiving port 150 may be a slot configured to receive selection plug in one of multiple orientations.

In various embodiments, and as seen in FIG. 2B, selection plug 200 comprises command guides 210 that, when plugged into the receiving port 150 of an audio device having a variable impedance system according to various embodiments of this disclosure, directs wire coils 152, 154, 156, and 158 into a plurality wiring configuration comprising the combination of series and/or parallel wiring needed to achieve the nominal impedance desired. In each of the plurality of wiring configurations of the plurality of voice coils, the audio device will have an associated nominal impedance (i.e. a different nominal impedance between a first wiring configuration and a second wiring configuration). In this way, selection plug 200 acts as a type of programming chip, wherein the configuration of command guides 210 arrange wire coils 152, 154, 156, and 158 into the proper parallel/series orientation correlating to a desired impedance.

In other embodiments, command guides 210 may be located on speaker 100, disposed within receiving port 150. In such embodiments, selection plug 200 may comprise an interface, such as, for example, a jumper, configured to contact command guides 210 in the specific orientation associated with the desired wiring configuration. For example, if selection plug 200 was placed in receiving port 150 in the 1-ohm position, it would contact command guides 210 in a first orientation, wherein the first orientation is associated with a first wiring configuration. If selection plug 200 was then removed and placed back in receiving port 150 in the 2-ohm position, it would contact command guides 210 in a second orientation, wherein the second orientation is associated with a second wiring configuration.

In various embodiments, command guides 210 may be any structure sufficient to connect and link various wire coils in the plurality of wire coils into the parallel and/or series configuration correlated with a desired nominal impedance. In various embodiments, command guides 210 may be raised structures extending from the selection plug 200. In various embodiments, command guides 210 may be inset structures extending inwardly in the selection plug 200. In various embodiments, command guides 210 may be comprised of any material suitable to create an electrical connection between the plurality of wire coils, such as, for example, copper, aluminum, silver, gold, alloys thereof, and/or combinations thereof. In various embodiments, command guides 210 may be copper traces on a printed circuit board (PCB), and/or the like. In an example embodiment, command guides 210 may comprise one or more prongs, suitable for insertion into one or more receptacles.

In various embodiments, plug 200 may comprise any interface sufficient to contact command guides 210 to wire coils 152, 154, 156, and 158 such as, for example, a plurality of fuses or a plurality of solid contacts.

In various embodiments, inserting selection plug 200 into speaker 100 may complete a wiring circuit formed by the wiring configuration of wire coils 152, 154, 156, and 158. Consequently, when selection plug 200 is removed from speaker 100, the wiring circuit is broken and has no set impedance.

In an example embodiment, the plug 200 is configured to form a seal when inserted in the receiving port. In this embodiment, the device for selecting the impedance also seals the configuration interface when engaged. This sealing capability helps protect the internal components of the speaker from external contaminants such as water, dust, and/or other particles which may damage or inhibit operation of the speaker. Thus, the plug 200 may comprise an interference fit, a gasket, or any suitable system for creating a seal against ingress of water, dust or the like.

In an example embodiment, the plug 200 is triangular and can be inserted in one of three positions selecting one of three impedance configurations, one for each of the three positions (corners of the triangular shape). In another example embodiment, the plug 200 is square and can be inserted in one of three or four positions (i.e., one position for each corner of the square). In this example embodiment, a first position corresponds with a first impedance, a second position corresponds with a second impedance that is different from the first impedance, a third position corresponds with a third impedance that is different from the first and second impedances. Furthermore, a fourth position may correspond with a fourth impedance that is different from the first, second and third impedances. In other example embodiments, other symmetrical shaped plugs may be used and configured for more than four positions for more than four impedance selectable settings. Stated another way, the plug may comprise any suitable shape that can be inserted into the receiving port in more than one orientation (from 0 degrees to 359 degrees), where insertion in differing orientations results in differing speaker impedance.

In other embodiments, plug 200 may be a plurality of plugs, each configured to set the impedance of speaker 100 at a single, distinct impedance value. For example, the plurality of plugs may comprise a first plug configured to set the impedance of speaker at 1-ohm, a second plug configured to set the impedance of speaker at 2-ohms, a third plug configured to set the impedance of speaker at 4-ohms, a fourth plug configured to set the impedance of speaker at 8-ohms, and/or any combination of the same. In this example embodiment, any suitable number of plugs may be used, with each plug, when inserted, setting the speaker impedance at a different value. In such embodiments, a set of differing impedance plugs could be provided, and an installer can select which plug to use for a particular installation. In such embodiments, each plug in the plurality of plugs may comprise the features of plug 200 as described above. However, the disclosure is not limited in this regard and includes any features suitable for instructing a plurality of wire coils in an audio device into a distinct series/parallel configuration to set a desired impedance.

In various embodiments, and as seen in FIG. 3, plug 200 may be placed into a configuration block 300 configured to correspond to the plurality of plug positions and mate with the receiving port 150 through their respective interfaces 310 and 160. In various embodiments, interface 310 may comprise any connector sufficient to enable a connection between command guides 210 and voice coil structure 141, such as, for example, a jumper. In various embodiments, interface 160 may comprise any connector sufficient to removably couple receiving port 150 to configuration block 300.

In various embodiments, configuration block 300 will merely act as an adapter for plug 200, allowing plug 200 to be used in larger receiving ports. In such embodiments, this may enhance the user experience, as the user may have greater control over a larger block-like plug as compared to a smaller chip design. Stated another way, the configuration block 300 may be configured to serve as an adapter between the plug 200 and a receiving port 150. In such embodiments, receiving port 150 may be a socket instead of a slot, configured to receive the larger configuration block 300.

In an example embodiment, the plug 200 comprises wiring connections for placing the voice coils in parallel and or series wiring configurations, thus changing the impedance of the speaker apparatus. In an example embodiment, the plug comprises connection ports for connecting to mating connecting ports in the speaker housing. In an example embodiment, the connection ports and mating connecting ports are aligned regardless of the way the plug is inserted (0, 90, 180, or 270 degree orientation), but each connection results in a different impedance setting for the speaker apparatus.

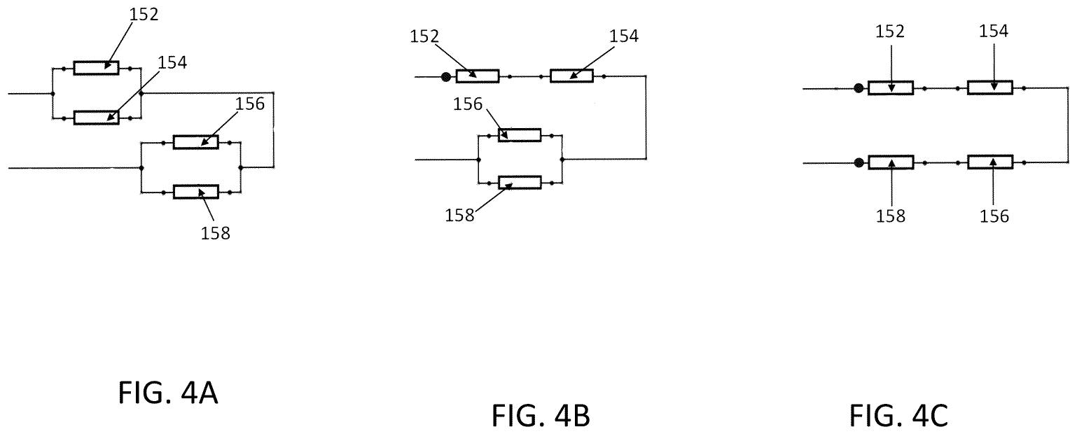

With reference now to FIGS. 4A-4C, a plurality of voice coils 152, 154, 156, and 158 are illustrated with an associated impedance. In this embodiment, voice coils 152, 154, 156, and 158 each have an individual impedance of 0.8-ohm. In an example embodiment, the impedance of the speaker 100 can be varied between 1-ohm, 2-ohms, and 4-ohms by connecting the plurality of voice coils in various parallel and series configurations. As illustrated by FIG. 4A, when selection plug 200 is placed into the receiving port in the 1-ohm position, coils 152 and 154 are wired in parallel with each other while coils 156 and 158 are wired in parallel with each other. The two parallel coil groups are then wired in series, resulting in a nominal impedance of 1-ohm. If a user desires to then change between 1-ohm and 2-ohms, they can simply remove the plug, place it in the receiving port in the 2-ohm position, and coils 152, 154, 156, and 158 will align in the new parallel and/or series configuration.

In such embodiments wherein coils 152, 154, 156, and 158 have an individual impedance of 0.8-ohm, an overall nominal impedance of 2-ohms is achieved by wiring coil 152 and 154 in series with each other and with the parallel coil group made up of coil 156 and 158, as shown in FIG. 4B. To achieve an overall nominal impedance of 4-ohms, coils 152, 154, 156, and 158 are all wired in series with each other, as shown in FIG. 4C.

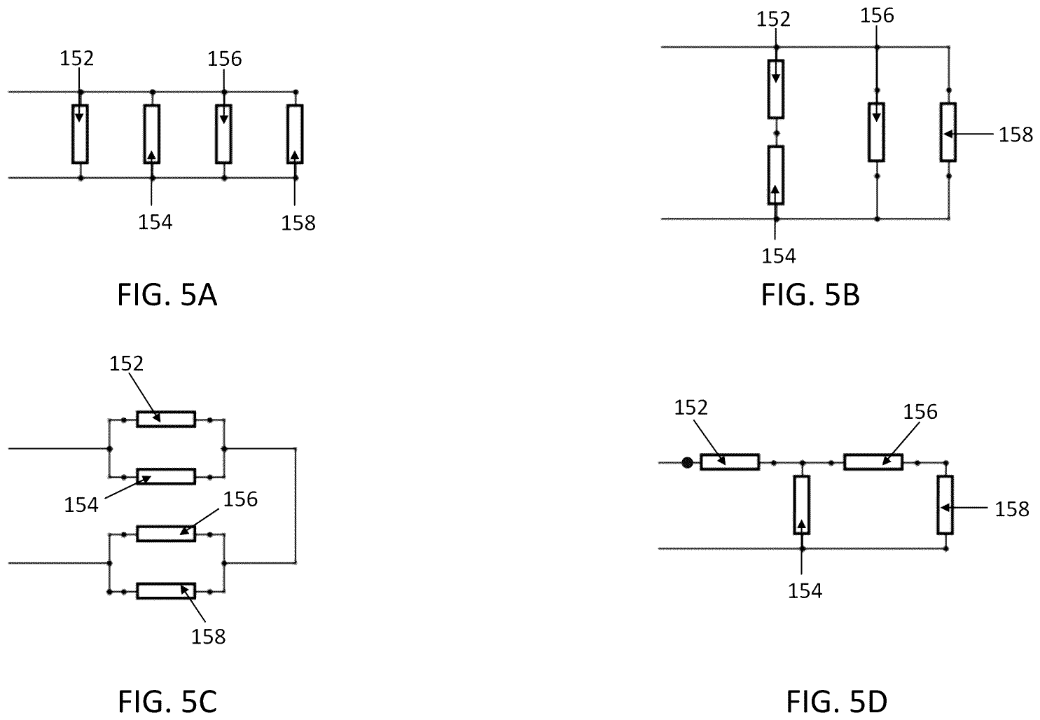

In other embodiments, such as when coils 152, 154, 156, and 158 have an individual impedance of 4-ohms, an overall nominal impedance of 1-ohm is achieved by wiring coils 152, 154, 156, and 158 in parallel with each other, as shown in FIG. 5A. To achieve an overall nominal impedance of 2-ohms, coils 152 and 154 are wired in series with each other, and then in parallel with coils 156 and 158, as shown in FIG. 5B. To achieve an overall nominal impedance of 4-ohms, coils 152 and 154 are wired in parallel with each other while coils 156 and 158 are wired in parallel with each other. The two parallel coil groups are then wired in series, as shown in FIG. 5C. To achieve an overall nominal impedance of 8-ohms, coils 156 and 158 are wired in series with each other and then in parallel with coil 154. Coil 152 is then wired in series with the resulting group, as shown in FIG. 5D.

In accordance with various aspects, the selection plug 200 is configured to facilitate convenience for users in properly configuring their sound system. Various conventional variable impedance systems are complicated because they make a larger variety of impedances accessible by the user, which makes it less likely that the user will set the impedance correctly for the system. Moreover, the system described herein can reduce the number of components a user needs to properly configure their sound system with the right impedance level. By providing such wide impedance ranges, a variable impedance system according to various embodiments of this disclosure will suit most speaker functionality needs. For example, in dual impedance speakers providing only 2-ohm and 4-ohm selection options, large swaths of corresponding devices are left incompatible, requiring a user to buy a 1-ohm speaker and an 8-ohm speaker in addition to the dual impedance speaker. Whereas, with three or four impedance options, many more configurations can be covered with the single selection plug.

Additionally, selection plug 200 is a significant improvement on prior selection devices, such as, for example, a switch or manual rewiring of circuits. Selection plug 200 has increased stability within speaker 100 and removes the possibility that an unintentional impedance shift can occur, as is an issue with traditional switches. Moreover, the simple insertion of selection plug 200 may be much easier and quicker to use than time-intensive manual rewiring. Additionally, the simple insertion of selection plug 200 has a significant advantage over use of jumpers and the like for reconfiguration of a speaker, which are prone to user error in wiring the speakers. Stated another way, the selection plug 200 limits the user to pre-designed options making it less prone to user error.

Example embodiments of the systems, methods, and devices described herein may be implemented in hardware, software, firmware, or some combination of hardware, software, and firmware.

In the present disclosure, the following terminology will be used: The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” means quantities, dimensions, sizes, formulations, parameters, shapes, and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including, for example, tolerances, measurement error, measurement accuracy limitations and other factors known to those of skill in the art, may occur in amounts that do not preclude the effect the characteristic was intended to provide. Numerical data may be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, but also include individual values and sub-ranges within the indicated range. Thus, included in the numerical range are individual values such as 2, 3 and 4 and sub-ranges such as 1-3, 2-4 and 3-5, etc. The same principle applies to ranges reciting only one numerical value (e.g., “greater than about 1”) and should apply regardless of the breadth of the range or the characteristics being described. A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

It should be appreciated that the particular implementations shown and described herein are illustrative of the example embodiments and their best mode and are not intended to otherwise limit the scope of the present disclosure in any way. Furthermore, the connecting lines shown in the various figures contained herein are intended to represent exemplary functional relationships and/or physical couplings between the various elements. It should be noted that many alternative or additional functional relationships or physical connections may be present in a practical device.

As one skilled in the art will appreciate, the mechanism of the present disclosure may be suitably configured in any of several ways. It should be understood that the mechanism described herein with reference to the figures is but one exemplary embodiment of the disclosure and is not intended to limit the scope of the disclosure as described above.

It should be understood, however, that the detailed description and specific examples, while indicating exemplary embodiments of the present disclosure, are given for purposes of illustration only and not of limitation. Many changes and modifications within the scope of the instant disclosure may be made without departing from the spirit thereof, and the disclosure includes all such modifications. The corresponding structures, materials, acts, and equivalents of all elements in the claims below are intended to include any structure, material, or acts for performing the functions in combination with other claimed elements as specifically claimed. The scope of the disclosure should be determined by the appended claims and their legal equivalents, rather than by the examples given above. For example, the operations recited in any method claims may be executed in any order and are not limited to the order presented in the claims. Moreover, no element is essential to the practice of the disclosure unless specifically described herein as “critical” or “essential.”

What is claimed:

1. A method for varying impedance in an audio device, comprising:
removing a selection plug from a receiving port of the audio device, wherein the selection plug comprises a plurality of command guides configured to wire a plurality of voice coils into a plurality of wiring configurations, wherein each wiring configuration in the plurality of wiring configurations corresponds to a plug position in a plurality of plug positions, wherein the plurality of voice coils comprises at least four voice coils and the plurality of wiring configurations comprises at least three wiring configurations, and wherein the selection plug when removed is at a first plug position in the plurality of plug positions; and
inserting the selection plug into the receiving port of the audio device in a second plug position in the plurality of plug positions, wherein the first plug position and the second plug position are different orientations of the selection plug;
wherein each wiring configuration in the plurality of wiring configurations is associated with a different impedance value for the audio device.

2. The method of claim 1, wherein the audio device is a subwoofer.

3. The method of claim 1, wherein the audio device is a coaxial speaker.

4. The method of claim 1, wherein each voice coil in the plurality of voice coils has a nominal impedance of about 0.8-ohm.

5. The method of claim 1, wherein each voice coil in the plurality of voice coils has a nominal impedance of about 4-ohms.

6. The method of claim 1, wherein each voice coil in the plurality of voice coils wraps around a former.

7. The method of claim 6, wherein the plurality of voice coils are wound in a single layer or a multi-layer around a former of the audio device.

8. The method of claim 1, wherein the audio device comprises an impedance value selected from a group comprising 1-ohm, 2-ohms, 4-ohms, and 8-ohms.

9. The method of claim 1, wherein the selection plug further comprises a plurality of fuses configured to interface the plurality of command guides to the plurality of voice coils.

10. An audio device, comprising:
a plurality of voice coils wound around a former;
a removable selection plug comprising a plurality of plug positions;
a receiving port configured to mate with the removable selection plug; and
a plurality of command guides configured to wire the plurality of voice coils into a plurality of wiring configurations, wherein each wiring configuration in the plurality of wiring configurations corresponds to a plug position in the plurality of plug positions, wherein the plurality of voice coils comprises at least four voice coils and the plurality of wiring configurations comprises at least three wiring configurations, and wherein each wiring configuration in the plurality of wiring configurations causes the audio device to have a different impedance value based on a relative orientation of the removable selection plug and the receiving port.

11. The audio device of claim 10, wherein each voice coil in the plurality of voice coils has a nominal impedance of about 0.8-ohm.

12. The audio device of claim 10, wherein each voice coil in the plurality of voice coils has a nominal impedance of about 4-ohms.

13. The audio device of claim 10, wherein the plurality of command guides are located on the removable selection plug.

14. The audio device of claim 10, wherein the plurality of command guides are disposed within the receiving port, and wherein the removable selection plug comprises a contact interface configured to contact the plurality of command guides in a distinct orientation corresponding to each plug position in the plurality of plug positions.

15. The audio device of claim 10, wherein the audio device comprises an impedance value selected from a group comprising 1-ohm, 2-ohms, 4-ohms, and 8-ohms.

16. The audio device of claim 10, wherein the audio device is a subwoofer.

17. The audio device of claim 10, wherein the audio device is a coaxial speaker.

18. The audio device of claim 10, wherein each voice coil in the plurality of voice coils is positionally adjacent to another voice coil in the plurality of voice coils.

19. The audio device of claim 10, wherein each plug position in the plurality of plug positions is unique.

20. The audio device of claim 13, wherein the removable selection plug further comprises a plurality of fuses configured to interface the plurality of command guides to the plurality of voice coils.
